(19) United States
(12) Patent Application Publication
(10) Pub. No.: US 2016/0242211 A1
(43) Pub. Date: Aug. 18, 2016

(54) RANDOM ACCESS METHOD FOR MACHINE TYPE COMMUNICATION TERMINAL

(71) Applicants: Hee Sang CHUNG, Daejeon (KR); Il Gyu KIM, Daejeon (KR)

(72) Inventors: Hee Sang CHUNG, Daejeon (KR); Il Gyu KIM, Daejeon (KR)

(73) Assignee: Electronics & Telecommunications Research Institute, Daejeon (KR)

(21) Appl. No.: 14/620,361

(22) Filed: Feb. 12, 2015

(51) Int. Cl. H04W 74/08; H04W 72/04; H04L 5/00; H04J 11/00; H04W 4/00

(52) U.S. Cl. CPC H04W 74/0833; H04J 11/0073; H04W 4/005; H04L 5/0007; H04W 72/042; H04W 72/0446; H04J 2011/0096

(57) ABSTRACT

Disclosed is a random access method for a machine type communication (MTC) terminal. The random access method performed by a terminal includes performing a cell search, determining a radio environment based on time taken to perform the cell search, and performing different random access procedures depending on the determined radio environment. Accordingly, coverage of the MTC terminal that is in a poor radio environment may be enhanced, thereby performing normal communication with a base station.

### CLAIM FOR PRIORITY

This application claims priority to Korean Patent Application No. 2014-0016008 filed on Feb. 12, 2014 in the Korean Intellectual Property Office (KIPO), the entire contents of which are hereby incorporated by reference.

### BACKGROUND

1. Technical Field

Example embodiments of the present invention relate in general to a wireless communication technology and more specifically to a random access method for a machine type communication terminal in a poor radio environment.

2. Related Art

Conventional communication systems have been mainly used as a communication means between people. Also, machine-to-machine (M2M) communication has traditionally received relatively little attention, but recently interest in machine-to-machine communication and its standardization has grown.

According to the European Telecommunications Standards Institute (ETSI), M2M is defined as communication between machines and things without human intervention. In addition, according to 3rd Generation Partnership Project (3GPP), machine type communication (MTC) is defined as data communication without the need for human intervention. In Korean M2M/IoT Forum, MTC is defined as communication for people or intelligent machines to provide machine type information through a broadcasting communication network or communication for controlling things.

As described above, the definition and range of communication between things (or M2M communication) are variously defined in each institute. Commonly, M2M communication denotes communication between machines with minimum human intervention in an initial stage, but the meaning of this word has been expanded from machine-to-machine communication to man-to-man communication.

Recently, as communication technology and information technology are combined to serve as a total solution for providing machine type information, M2M communication has become a representative IT convergence industry.

That is, M2M communication has expanded its range of applications to be a total solution for providing machine type information in which communication technology and information technology are combined, beyond the communication function between man and machine or between machines. M2M communication was mainly applied to telematics, remote meter reading, location tracking, and so on in the initial state, and is recently applied to fields such as energy, transport, architecture, home appliances, health, and consumer terminal. For example, M2M communication may be utilized for traffic management, navigation, and fleet management in a transport field and may be utilized for lighting, fire prevention, and smart home in an architecture field.

Along with activation of M2M communication as described above, the 3rd Generation Partnership Project (3GPP), which is a representative standardization organization for mobile communication in Europe, began a feasibility study for M2M communication in 2005 and has been conducting a standardization work for machine type communication (MTC) based on Long Term Evolution (LTE)/LTE-Advanced (LTE-A) communication scheme since 2008.

In a physical layer standardization proceeding situation of the machine type communication standardization work that has been conducted by the 3GPP, a primary discussion on a study item of “Study on Provision of Low Cost MTC UEs based on LTE” had been completed by March, 2012. This means a discussion on a technique related to low cost MTC UEs.

In general, low cost MTC user equipments (UEs) may be easily implemented by excluding some of functions included in existing LTE terminals. However, when the low cost MTC UE is implemented by excluding some of the functions included in the LTE terminal, service coverage of the low cost MTC UE may be decreased, which may cause a communication interruption.

Accordingly, a method of a low cost MTC UE normally performing data communication in a poor radio environment by enhancing the coverage of the MTC UE is required.

### SUMMARY

Accordingly, example embodiments of the present invention are provided to substantially obviate one or more problems due to limitations and disadvantages of the related art.

Example embodiments of the present invention provide a random access method for a machine type communication terminal, which may enhance service coverage of the machine type communication terminal.

The object of the present invention is not limited to the aforesaid, but other objects not described herein will be clearly understood by those skilled in the art from descriptions below.

In some example embodiments, a random access method performed by a terminal includes performing a cell search, determining a radio environment based on time taken to perform the cell search, and performing different random access procedures depending on the determined radio environment.

The performing of the cell search may include acquiring time and frequency synchronization and a physical layer cell identity and measuring time taken to completely decode a physical broadcast channel (PBCH). The performing of the cell search may include acquiring time and frequency synchronization and a physical layer cell identity and measuring time taken to completely decode a system information block (SIB).

The determining of a radio environment based on time taken to perform the cell search may include comparing the time taken to perform the cell search with a reference time, determining the radio environment as a first radio environment when the time taken to perform the cell search is shorter than the reference value, and determining the radio environment as a second radio environment when the time taken to perform the cell search is longer than the reference value.

The performing of different random access procedures depending on the determined radio environment may include performing the random access procedures using predetermined different resources depending on the determined radio environment, and the predetermined different resources may have different sizes.

The performing of different random access procedures depending on the determined radio environment may include, when the determined radio environment is the first radio environment, decoding a system information block, acquiring first resource group information for transmitting a random access preamble from the decoded system information block, and transmitting the random access preamble using any preamble sequence included in the first resource group.

The performing of different random access procedures depending on the determined radio environment may include, when the determined radio environment is the second radio environment, decoding a system information block, acquiring second resource group information for transmitting a random access preamble from the decoded system information block, and transmitting the random access preamble using any preamble sequence included in the second resource group.

The decoding of the system information block may include repeatedly receiving and decoding the system information block.

The transmitting of the random access preamble may include repeatedly transmitting the random access preamble.

In other example embodiments, a random access method performed by a base station includes broadcasting system information including resource division information, receiving a random access preamble transmitted based on the system information, determining a used resource group from the received random access preamble, and transmitting a random access response in a different scheme based on the determined resource group.

The resource division information may be division information of a first resource group and a second resource group a terminal selects and uses according to a radio environment determined by the terminal.

The determining of a used resource group from the received random access preamble may include determining whether a preamble sequence of the random access preamble belongs to the first resource group or the second resource group.

The transmitting of a random access response in a different scheme based on the determined resource group may include repeatedly transmitting the random access response when the determined resource group belongs to the second resource group.

The transmitting of a random access response in a different scheme based on the determined resource group may include transmitting the random access response using a plurality of transmission time intervals (TTIs) when the determined resource group belongs to the second resource group.

### BRIEF DESCRIPTION OF DRAWINGS

Example embodiments of the present invention will become more apparent by describing in detail example embodiments of the present invention with reference to the accompanying drawings, in which:

FIG. 1 is a flowchart showing an initial access process of an LTE terminal;

FIG. 2 is a graph showing an average cell search time according to a signal-to-noise ratio of a received signal;

FIG. 3 is a flowchart showing a cell search procedure according to an embodiment of the present invention;

FIG. 4 is a flowchart showing a cell search procedure according to another embodiment of the present invention;

FIG. 5 is a conceptual view showing resources used in a random access method according to an embodiment of the present invention;

FIG. 6 is a flowchart showing a random access process according to an embodiment of the present invention; and

FIG. 7 is a flowchart showing operations performed by a base station during a random access process according to an embodiment of the present invention.

### DESCRIPTION OF EXAMPLE EMBODIMENTS

The present invention may be variously changed and may have various embodiments. Hereinafter, preferred embodiments of the present invention will be described in detail with reference to the accompanying drawings.

However, it should be understood that the present invention is not limited to these embodiments, and may include any and all modification, variations, equivalents, substitutions, and the like within the spirit and scope thereof.

The terms used in the present specification are set forth to explain the embodiments of the present invention, and the scope of the present invention is not limited thereto. The singular number includes the plural number as long as they are not apparently different from each other in meaning. In the present specification, it will be understood that the terms “have,” “comprise,” “include,” and the like are used to specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. Terms, such as terms that are generally used and have been in dictionaries, should be construed as having meanings matching contextual meanings in the art. In this description, unless defined clearly, terms are not interpreted in an idealized or overly formal sense.

Hereinafter, preferred embodiments of the present invention will be described in detail with reference to the accompanying drawings. In describing the invention, in order to facilitate the entire understanding of the invention, like numbers refer to like elements throughout the description of the figures and the repetitive description thereof will be omitted.

Embodiments of the present invention that will be described below may be supported by standard documents that are disclosed in at least one of an Institute of Electrical and Electronics Engineers (IEEE) 802 system, a 3rd Generation Partnership Project (3GPP) system, a 3GPP LTE/LTE-Advanced system, and a 3GPP2 system, which are wireless access systems. The steps or parts that are not described to clearly reveal the technical idea of the present invention, in the embodiments of the present invention may be supported by the above documents. All terminology used herein may be supported by at least one of the above-mentioned standard documents.

The term “terminal” used herein may be referred to as a mobile station (MS), a user equipment (UE), a mobile terminal (MT), a user terminal (UT), a wireless terminal, an access terminal (AT), a subscriber unit, a subscriber station (SS), a wireless device, a wireless communication device, a wireless transmit/receive unit (WTRU), a mobile node, a mobile, or the like.

In addition, the term “base station” used herein may be referred to as a controller that controls one cell. However, a physical base station in an actual wireless communication system may control a plurality of cells, and in this case, the physical base station may be regarded as including one or more of the base stations that are described herein. For example, it should be understood that each base station assigns different values to parameters assigned differently for each cell in this specification. In addition, the term “base station” used herein may be referred to as a base station (BS), a node-B, an eNode-B, a base transceiver system (BTS), an access point, a transmission point, and so on.

First, a method of reducing a price of an MTC terminal will be described below.

When an LTE-based MTC terminal and a normal LTE terminal (normal LTE UE) are considered in terms of a physical layer, key points are performance and prices of the terminals. The LTE-based MTC terminal should not have lower performance than a Global System for Mobile Communications (GSM)-based MTC terminal, and should have a lower price than a normal LTE terminal. Here, the normal LTE terminal denotes an LTE support type terminal that is used by a person, and the LTE MTC terminal (hereinafter, referred to as an “MTC terminal”) denotes a terminal that is used in an MTC application and without human intervention.

The following six methods may be considered as the method of reducing a price of an MTC terminal.

A first method is to reduce a maximum bandwidth of the MTC terminal. That is, the reduction of the maximum bandwidth enables cost reduction of radio frequency (RF) components and cost reduction caused by simplifying a baseband process by the low cost MTC terminal reducing the bandwidth to 5 MHz, 3 MHz, 1.4 MHz, etc., compared to the LTE terminal that supports the bandwidth of up to 20 MHz.

A second method is to configure the MTC terminal to use a single receiving RE That is, unlike the LTE terminal that is basically configured to use an RF device for receiving two signals, the low cost MTC terminal reduces the number of RF devices down to 1, thereby decreasing production costs.

A third method is to reduce a maximum peak rate of the MTC terminal. That is, the price of the MTC terminal is decreased by reducing complexity of a baseband related to a maximum transmission rate since the maximum transmission rate of the MTC terminal is significantly lower than that of the normal LTE terminal.

A fourth method is to reduce a transmission power of the MTC terminal. That is, the normal LTE terminal may be configured to use up to 200 mW when transmitting a signal on an uplink, and the MTC terminal reduces the transmission power down to 200 mW or less, thereby reducing a cost of the RF device.

A fifth method is to configure the MTC terminal to use a half duplex mode. The half duplex mode denotes that transmission and reception are not performed simultaneously, and may allow the MTC terminal to use the half duplex mode to remove a duplexer having a relatively high device cost from among the RF devices, thereby reducing production costs of the MTC terminal.

A sixth method is to reduce a transmission mode the MTC terminal supports. The normal LTE terminal supports transmission mode 1 to transmission mode 10. However, since the MTC terminal need not support all of the transmission modes, the MTC terminal may be configured to support only some of the transmission modes, thereby reducing complexity of a baseband processing unit and thus decreasing production costs of the MTC terminal. When three methods having a large effect on a price fall among the six methods for producing the low cost MTC terminal are applied simultaneously, the price of the MTC terminal may be reduced to about half the price of the LTE terminal.

However, the above-described methods lead to a problem of reducing service coverage of the MTC terminal. For example, in a case in which an available bandwidth of the MTC terminal is reduced, coverage is reduced since the MTC terminal cannot use frequency diversity characteristics or frequency selectivity characteristics the LTE terminal may use or an effect of the characteristics is very small even when the MCT terminal uses the characteristics. In addition, when the MTC terminal is configured to use the single receiving RF, reduction of a received-energy combining gain of the MTC terminal may be caused. Furthermore, reduction of the transmission power of the MTC terminal leads to reducing uplink coverage of the MTC terminal. However, a current standard specification does not include reduction in performance of the low cost MTC terminal.

Accordingly, in addition to the methods for the low cost MTC terminal as described above, a method of compensating for reduction in coverage of the MTC terminal due to the above-described methods should be also considered for communication of the MTC terminal.

In an embodiment of the present invention, a data transmission procedure for increasing coverage of the MTC terminal is presented. For convenience of description, the procedure will be described using an example of increasing the coverage of the MTC terminal by 20 dB. However, the technical spirit of the present invention is not limited to increasing the coverage of the MTC terminal by 20 dB, and the degree of increasing the coverage of the MTC terminal may be set to various values.

A need to increase the coverage of the low cost MTC terminal will be described below.

Various complementary measures are required for a case in which the coverage of the MTC terminal is decreased because of the above-described methods of reducing the price of the MTC terminal. The coverage of the MTC terminal may need to be increased in addition to the complementary measures to the reduction of the coverage of the MTC terminal.

For example, smart metering, which is a representative MTC application, requires an additional increase in the coverage. That is, since a place in which electricity, water, and gas are metered (or places in which the MTC terminal is installed) in the smart metering with the MTC terminal is generally a place in which it is difficult for radio waves to penetrate such as a basement of a building, communication may not be smoothly performed, compared to a case in which the MTC terminal is installed in a place in which a radio environment is good. Although many MTC terminals for smart metering are positioned in a place in which the radio environment is good, and some MTC terminals are installed in the above-described poor radio environment, it is important to allow all the MTC terminals to normally receive a service.

The meaning of increasing the coverage of the low cost MTC terminal will be described below.

First, a maximum coupling loss (MCL) is defined for each of uplink and downlink physical channels used in the existing LTE/LTE-A system.

A value of the maximum coupling loss (MCL) is obtained by subtracting a receiving sensitivity from transmission power. As the maximum coupling loss increases, the coverage increases. Table 1 shows the MCL values (in dB) according to a duplexing scheme (FDD or TDD) with respect to a physical uplink control channel (PUCCH), a physical random access channel (PRACH), a physical uplink shared channel (PUSCH), a physical downlink shared channel (PDSCH), a physical broadcast channel (PBCH), a synchronization channel (SCH), and a physical downlink control channel (PDCCH), which are physical channels used in the LTE/LTE-A system.

TABLE 1

| | PUCCH | PRACH | PUSCH | PDSCH | PBCH | SCH | PDCCH |
|---|---|---|---|---|---|---|---|
| FDD | 147.2 | 141.7 | 140.7 | 145.4 | 149.0 | 149.3 | 146.1 |
| TDD | 149.4 | 146.7 | 147.4 | 148.1 | 149.0 | 149.3 | 146.9 |

Referring to Table 1, in the FDD, a minimum value of the MCL is 140.7 of the PUSCH, and a maximum value is 149.3 of the SCH. In the TDD, a minimum value of the MCL is 146.7 of the PRACH, and a maximum value is 149.3 of the SCH. Here, the reason why the MCL values of the FDD and the TDD are different depending on the physical channels is that assumptions for performance evaluation are different. That is, the FDD assumes that there are 2 transmission antennas and 2 reception antennas (2×2), while the TDD assumes that there are 8 transmission antennas and 8 reception antennas (8×8).

The increasing the coverage of the low cost MTC terminal means increasing the MCL values shown in Table 1. Here, when it is assumed that a target MCL value is 20 dB, the target MCL value is different depending on the physical channel. That is, when it is assumed that an MCL value (or coverage) of the PUSCH having the smallest value is increased by 20 dB, the coverage of the FDD system is considered to be entirely enhanced by 20 dB by enhancing the SCH by 11.4 dB. In contrast, since the TDD has a difference between MCL values of the physical channels (that is, a minimum MCL value and a maximum MCL value) of 2.6 dB, all the physical channels should be equally enhanced, compared to the FDD. If the TDD enhances the MCL value of the PRACH, which has the smallest MCL value, by 20 dB, the MCL value of the SCH should be enhanced by 17.4 dB.

A method of enhancing coverage or MCL value of each physical channel will be described below. In order to enhance coverage of the low cost MTC terminal, a technique for enhancing coverage for each physical channel and physical signal should be applied.

The SCH includes a primary synchronization signal (PSS) and a secondary synchronization signal (SSS), which are transmitted at certain intervals of 5 ms. Accordingly, the coverage of the SCH may be enhanced in a method of collecting energy corresponding to information bits by accumulating a received signal (that is, SCH) when time and frequency synchronization acquisition and physical layer cell identity (PCI) acquisition are performed by a receiver of the MTC terminal. However, the MTC terminal that is positioned close to the base station and thus has a high receiving power may successfully detect the SCH even by receiving the SCH only one time. However, when the MTC terminal is positioned far from the base station and installed in a place in which a radio environment is poor, such as a basement, the receiving power may be small, and thus the MTC terminal can scarcely perform successful detection by receiving the SCH only one time. In a case in which the radio environment of the MTC terminal is poor, the MTC terminal may receive the SCH a predetermined number of times (for example, 100, 200, or 300 times) and accumulate the received signals to normally detect the SCH. Here, in principle, the base station can amplify and transmit the SCH when receiving a signal. Actually, the scheme of amplifying a signal to be transmitted and transmit the amplified signal increases coverage of all the channels.

The PBCH is a channel for transporting some of system information needed for a terminal to access a network, which carries a downlink bandwidth, a physical hybrid-ARQ indication channel (PHICH) configuration, and a system frame number (SFN) at intervals of 40 ms. Among the above described information, the system frame number (SFN) is changed every 40 ms and thus may not be continuously accumulated. However, when the system frame number (SFN) is removed from the PBCH information, performance may be enhanced by accumulating the PBCH. In addition, when a bandwidth used for the MTC is fixedly determined and a signal is retransmitted through the PDCCH instead of the PHICH, the PBCH may not be needed. Another method for enhancing the coverage of the PBCH is to change a specification to increase the amount of resources that are used in the PBCH. However, disadvantageously, this method decreases spectral efficiency.

The PRACH is a channel that is used for a terminal to perform random access to a network, which is an uplink synchronization signal that is transmitted from the terminal to the base station. The coverage of the PRACH may be enhanced by the MTC terminal transmitting the PRACH repeatedly or in an extended sequence length. However, since such a method involves changing the method of transmitting the PRACH itself, a change of a standard specification is needed. In addition, the MTC terminal that transmits the PRACH should receive a response within a transmission window defined in the standard specification. When the MTC terminal transmits the PRACH repeatedly or in an extended sequence, the response is also delayed. Accordingly, a delay time for a response message to the PRACH should be added.

The PDCCH is a downlink control channel, which is used to transmit control information such as a scheduling needed to receive the PDSCH and transmit scheduling approval for transmission in the PUSCH. In order to enhance coverage of the PDCCH, an aggregation level that is originally set to 1, 2, 4, and 8 is expanded to 16, 32, and so on to apply a method of using more energy. Additionally, a bundling method may be used in which a payload size of the PDCCH is reduced to increase a coding rate and a control channel element is transmitted over several subframes. However, since the above-described methods of enhancing the PDCCH coverage is not defined in the existing standard specification, a new standard specification is required to be introduced.

The PUCCH is an uplink control channel, which is used to transmit information such as a hybrid automatic retransmission request-acknowledgement (HARQ-ACK), a service request (SR), and a channel state information (CSI). For the low cost MTC terminal, a method that does not use the HARQ-ACK may be used. Alternatively, the MTC terminal is allowed to use, but repeatedly transmit, the HARQ-ACK to extend the coverage of the PUCCH. Considering that MTC data traffic occurs at rare intervals, the SR may be replaced by transmitting the PRACH in terms of its function, and the CSI may not be transmitted.

The PUSCH, which is an uplink data channel, and the PDSCH, which is a downlink data channel, may use Transmit Time Interval (TTI) bundling in which data is transmitted over several TTIs. Alternatively, a method of drastically increasing the number of retransmissions of the PUSCH and the PDSCH may be applied. Alternatively, for the PDSCH, a method of enhancing coverage by supporting only specific terminals at a specific time to increase transmission power of the PDSCH may be applied.

The above description has been provided with respect to the methods of enhancing coverage for each physical channel. A common point between the above-described methods of enhancing the coverage is that more energy is required to be transferred in order to increase the coverage. However, as a result, the transferring of more energy means that it takes longer time to transmit a signal, in consideration that energy resources that may be used by a terminal or base station are limited.

Meanwhile, since the uplink or downlink data traffic is considered to be very small in the MTC, compared to general mobile communication, a long data transmission time may be acceptable. For example, for smart metering, it is considered that 100 bytes of data are transmitted via an uplink for 1 hour, and 20 bytes of data are transmitted via a downlink for 10 seconds.

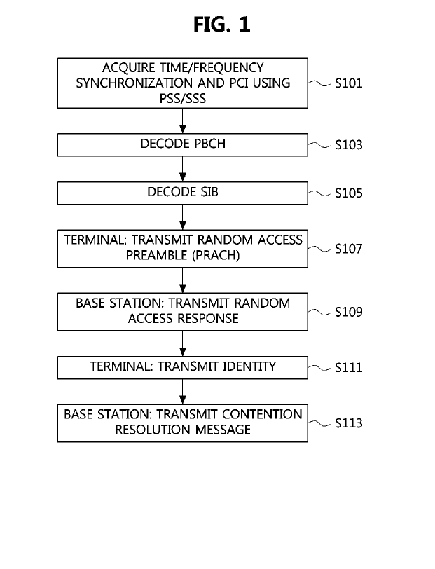

FIG. 1 is a flowchart showing an initial access process of an LTE terminal, which shows a procedure that is performed for the LTE terminal to access an LTE-based network.

Referring to FIG. 1, when the LTE terminal is powered on, the LTE terminal first performs a cell search to access a network. The cell search is a process of acquiring frequency and symbol synchronization with a cell, acquiring frame synchronization of the cell, that is, a start time of a downlink frame, and determine a physical layer cell identity (PCI) of the cell.

The LTE system defines 504 different physical layer cell identities, each of which corresponds to one specific downlink reference signal sequence. In addition, the physical layer cell identities are divided into 168 cell identity groups, each of which has three identities.

To help the cell search of the terminal, the LTE system transmits two special signals of a primary synchronization signal (PSS) and a secondary synchronization signal (SSS), and the LTE terminal acquires time and frequency synchronization and a physical layer cell identity (PCI) using the PSS and the SSS (S101).

In one cell, the same PSS is transmitted twice in a frame. The PSS in one cell may have 3 different values depending on a physical layer cell identity of the cell. That is, three physical layer cell identities in one physical layer cell identity group correspond to different PSSs.

Accordingly, the LTE terminal may identify a physical layer cell identity in a physical layer cell identity group and a 5-ms time of the cell by detecting and checking the PSS of the cell. Here, since the LTE terminal cannot identify the physical layer cell identity group, the number of available cell identities is 168. Subsequently, the LTE terminal may identify a cell identity group among 168 physical layer cell identity groups and a frame timing by detecting and checking the SSS and may determine time and frequency synchronization, frame synchronization, and a physical layer cell identity of the cell through the above process.

When the LTE terminal performs synchronization with the cell and acquires the physical layer cell identity and the frame synchronization through the basic cell search procedure of S101, the LTE terminal is required to acquire system information of the cell.

The system information of the cell is information that is repeatedly broadcast by the network and includes downlink and uplink cell bandwidths, detailed parameters related to random access, uplink power control information, and so on as information that the terminal is required to identify in order for the terminal to access the cell and properly operate in the cell.

The LTE terminal decodes the PBCH broadcast from the base station to acquire the system information that is called a master information block (MIB) (S103).

The MIB includes a very limited amount of system information, which may include a downlink cell bandwidth, information on PHICH setting of the cell, and information on the system frame number (SFN). Here, one broadcast channel (BCH) transport block, corresponding to the MIB, is transmitted every 40 ms.

Subsequently, the LTE terminal decodes a system information block (SIB) (S105). The SIB is transmitted through the PDSCH allocated with resources and a limited transmission mode to transmit main parts of the system information. There are 13 or more SIBs and a certain SIB may not be used depending on the case. In addition, as an SIB number is smaller, the importance of the SIB is higher, and as the importance of SIB is higher, the SIB is more frequently transmitted.

SIB1 having the highest importance among SIBs may include information on whether the LTE terminal accesses the cell to use a service. That is, SIB1 includes provider information of the cell, constraints of a terminal that may access the cell, subframe allocation information for the downlink/uplink in the TDD, scheduling information on a time domain of other SIBs, etc.

SIB2 includes information needed for the LTE terminal to access the cell. That is, SIB2 includes an uplink bandwidth, a random access parameter, a parameter related to uplink power control, and so on.

SIB3 includes information related to cell reselection.

SIB4 to SIB8 include information about neighboring cells.

SIB9 includes the name of a Home-eNodeB.

SIB10 to SIB12 include public warning information such as an earthquake warning.

SIB13 includes information needed to receive a multimedia broadcast/multicast service (MBMS).

When the decoding of the SIB is completed through the above-described process, the LTE terminal is ready to perform a random access via the uplink.

The random access is used to establish synchronization between the LTE terminal and the base station in addition to informing the presence of the LTE terminal to the base station. That is, the base station may measure a transmission delay time of a signal transmitted from the LTE terminal through the random access procedure and may transmit information for synchronization with the LTE terminal to the LTE terminal.

Specifically, the random access process may include four steps below.

First, the LTE terminal transmits a random access preamble to the base station such that the base station may estimate a transmission timing (or a transmission delay time) of the terminal (S107). Here, the LTE terminal may transmit the random access preamble to the base station through the PRACH.

The base station transmits a random access response via the downlink in response to the random access preamble transmitted from the LTE terminal (S109). The random access response may include an index of a random access preamble sequence the base station detects, timing advance information for correcting transmission delay times of the base station and the terminal, which are estimated through the random access preamble, scheduling approval information for indicating resources that are used by the LTE terminal to transmit a message at the next step, and temporary cell radio network temporary identifier (TC-RNTI) information used for additional communication between the LTE terminal and the base station.

The LTE terminal transmits its identity to the base station based on uplink timing advance information included in the random access preamble response received from the base station in S109 (S111).

Last, the base station transmits a contention resolution message to the LTE terminal, thereby completing the random access procedure (S113).

A need for a new access procedure for the MTC terminal will be described below.

Actually, it is difficult for the MTC terminal that is in a poor radio environment to access the base station through an initial access process as shown in FIG. 1.

The MTC terminal first performs a cell search process when performing an initial access procedure. In this case, the time and frequency synchronization and the physical layer cell identity can be acquired through the PSS and the SSS by increasing the number of times the received signal is accumulated without changing the current standard specification. That is, the MTC terminal may be implemented to accumulate the received signal a predetermined number of times only when a radio environment is poor and may not be used in a normal radio environment.

However, in a PBCH decoding process performed after the cell search process, when the base station transmits the PBCH according to the existing standard specification, the MTC terminal cannot decode the PBCH normally. When the radio environment is poor, a signal-to-noise ratio is very low and thus a large number of received signals are required to be accumulated to collect energy of the received signals. However, since an SFN value included in the PBCH changes at intervals of 40 ms, it is impossible to accumulate the same signal. Accordingly, in the access procedure for the MTC terminal, as an alternative for normally decoding the PBCH, the number of resources the PBCH occupies may be increased through the change of the standard specification, the SFN may be excluded from the PBCH, or the PBCH information may not be used at all.

Next, the MTC terminal decodes the SIB when the MTC terminal performs normal decoding of the PBCH through the above-described method. The SIB is transmitted through the physical channel that is PDSCH. However, when the radio environment is poor, the signal-to-noise ratio is very low and thus energy combining or repetitive reception of the received signal is needed. Since the SIB includes system information and is transmitted from the base station periodically, the coverage may be enhanced through the above-described method of improving the coverage of the PDSCH or PDCCH.

When the MTC terminal that is in the poor radio environment performs the above-described procedures successfully, the MTC terminal performs a random access procedure for accessing the base station.

First, the MTC terminal transmits the random access preamble to the base station through the PRACH, and the base station cannot receive and detect the PRACH that is transmitted from the MTC terminal that is in the poor radio environment since the base station cannot be aware of the radio environment of the MTC terminal. Here, the base station should be able to receive the PRACH transmitted by the MTC terminal that is in a poor radio environment while receiving the PRACH transmitted by the MTC terminal or LTE terminal that is in a good radio environment. However, such a procedure needs to be newly configured since the procedure is not defined in the existing standard specification.

That is, a method of transmitting or receiving physical channels other than a synchronization signal between the MTC terminal that is in the poor radio environment and the base station should be changed from the conventional method of performing transmission or reception between the LTE terminal and the base station, thereby needing a procedure for supporting the change.

Accordingly, the present invention provides a random access method for the MTC terminal that may support a low data transmission rate to access the base station in a very poor radio environment and transmit or receive data to or from the base station.

The random access method for the MTC terminal according to an embodiment of the present invention will be described below.

As described above, a general random access method for the LTE terminal cannot be applied to the random access method for the MTC terminal that supports a low transmission rate and is in a poor radio environment, and thus the random access method needs to be optimized for characteristics of the MTC terminal.

First, the base station may not recognize the radio environment of the MTC terminal before the MTC terminal accesses the base station. Accordingly, the present invention is configured such that identification of the radio environment of the MTC terminal is performed not by the base station but by the MTC terminal. For example, the identification of whether the MTC terminal is in a region in which a radio communication state is good or a region in which the radio communication state is poor may be performed at the beginning of a process of receiving a synchronization signal of the MTC terminal.

That is, when it takes a short time to successfully complete acquiring the time and frequency synchronization of the MTC terminal, acquiring the physical layer cell identity, and performing the PBCH decoding, the MTC terminal may be determined to be in the place in which the radio environment is good. In contrast, when it takes a long time, the MTC terminal may be determined to be in the place in which the radio environment is poor.

When the MTC terminal is determined to be in the region in which the radio environment is poor such as a basement of a building, in order to successfully finish the above-described cell search process, the number of times the signal is accumulated needs to be increased, and thus time taken for the MTC terminal to finish the cell search becomes relatively long. Since the PSS is periodically transmitted every 5 ms, it takes 1 second to perform the detection after the PSS is accumulated 200 times. Here, when the accumulation of the SSS is additionally performed 200 times, one second is added. It may take 20 ms in the normal radio environment, but it may take 100 times as long in the poor radio environment.

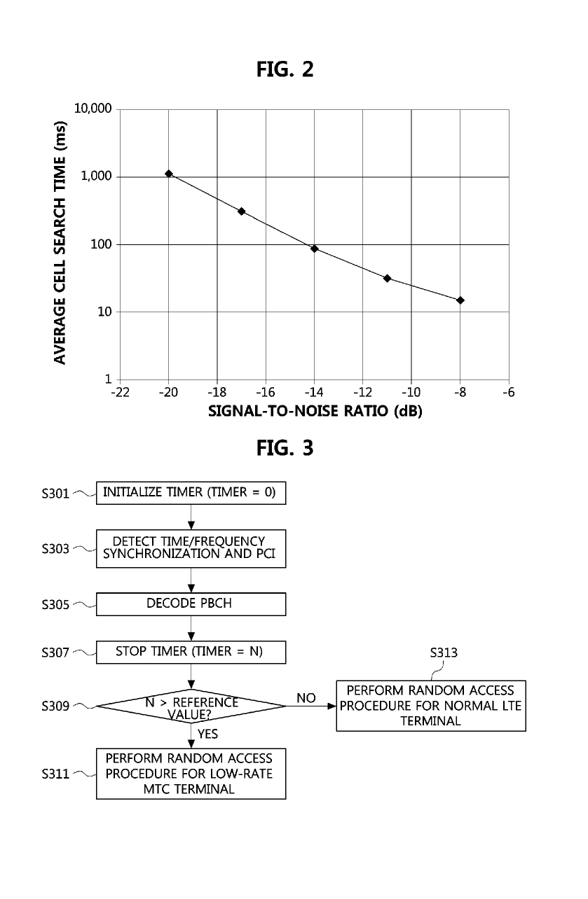

FIG. 2 is a graph showing an average cell search time according to a signal-to-noise ratio of a received signal, which illustrates a simulation result for checking time taken in the cell search.

As simulation conditions, a frequency band is set to 1.4 MHz, a frame structure is set to the FDD, a carrier frequency is set to 2 GHz, a channel model is set to Extended Pedestrian A model (EPA), an initial frequency offset is set to 1 kHz, and a Doppler shift is set to 1 Hz.

In FIG. 2, a horizontal axis represents a signal-to-noise ratio (SNR, in dB), and a vertical axis represents an average cell search time (in ms).

A lower SNR value denotes a poorer radio environment, and when the simulation result is that the SNR decreases to −20 dB, the time taken in the cell search is about 1.1 seconds on average.

That is, as shown in the simulation result graph of FIG. 2, the cell search time increases as the radio environment becomes poor, which means the cell search time should be increased when the radio environment is poor.

FIG. 3 is a flowchart showing a cell search procedure according to an embodiment of the present invention, which illustrates the cell search procedure performed by the MTC terminal.

Referring to FIG. 3, in the cell search process according to an embodiment of the present invention, the MTC terminal initializes a timer provided to measure time taken in the cell search procedure to zero (S301), and increases a value of the timer at the same time that the cell search procedure begins. Here, the timer denotes an entity for measuring time. Subsequently, the MTC terminal acquires the time and frequency synchronization using the PSS and the SSS that are broadcast from the base station and detects the physical layer cell identity (S303).

Next, the MTC terminal decodes the received PBCH to acquire the MIB information (S305).

The timer keeps increasing during S303 and S305 after the timer is initialized to zero in S301, and stops increasing when the MTC terminal successfully finishes the PBCH decoding. FIG. 3 illustrates that a timer value at a time when the MTC terminal successfully finishes the PBCH decoding is N.

Subsequently, the MTC terminal compares the timer value N with a predetermined reference value (S309). Here, the reference value is not limited to a specific value, and may be set variously depending on the radio environment. An embodiment of the present invention assumes that the reference value is set to 1 second for convenience of description. As described above, 100 ms is sufficient for the time taken for the MTC terminal to finish the PBCH decoding when the radio environment is not poor but normal. Accordingly, the time taken being 1 second or longer means that the radio environment is very poor. Here, the reference value may be further subdivided into 1 second, 2 seconds, 3 seconds, 10 seconds, etc. and be configured to perform a procedure according to various radio environments. In this case, since a standard specification for performing the procedure becomes complicated, the present invention illustrates a case in which the reference value is simplified. However, depending on the case, it may be needed to set the reference value that is compared with the timer value N as a larger value such as 2 seconds or 5 seconds. This setting is used to distinguish a case in which a radio environment of the MTC terminal is very poor from a case in which the radio environment is not very poor. In addition, an embodiment of the present invention illustrates that the radio environment is simplified and determined for convenience of description. However, further subdividing the radio environment is also included in a technical spirit of the present invention. For example, in an additional embodiment of the present invention, a plurality of reference values may be set instead of the single reference value, and the access procedure may be multiplexed according to the plurality of reference values, rather than duplexed.

When the determination result in S309 is that the timer value N is larger than a reference value (for example, 1 second), the MTC terminal determines that the radio environment is very poor and performs an access procedure for a low-rate LTE terminal (S311).

When the determination result in S309 is that the timer value N is smaller than the reference value, the MTC terminal performs an access procedure for a normal LTE terminal (S313). Here, the normal LTE terminal may be an MTC terminal or an LTE terminal. In addition, the low-rate LTE terminal may also be the MTC terminal or the LTE terminal. However, when the low-rate LTE terminal is not the MTC terminal, the low-rate LTE terminal need not perform the access procedure of the low-rate LTE terminal. That is, when the low-rate LTE terminal is the MTC terminal having a target of periodically transmitting or receiving data with a small size, it is preferable to perform an appropriate access procedure for the MTC terminal. That is because the LTE terminal has different transmission and reception data from the MTC terminal.

In addition, the access procedure of the low-rate LTE terminal performed in S311 means performing a network access procedure through a method of repeatedly receiving a signal and accumulating the received signal as described above.

Since the MTC terminal performing cell search may receive a signal several times using only one cell searcher that performs normal cell search, even in a case in which the method is used, an additional further hardware device need not be included. However, in order to facilitate performing, or improve the speed of the network access procedure, separate hardware devices for the general radio environment and the poor radio environment may be implemented and simultaneously operated in parallel. This is irrespective of a signal transmission side (for example, a base station), and a signal reception side (for example, a terminal) may selectively make determination.

FIG. 4 is a flowchart showing a cell search procedure according to another embodiment of the present invention.

Referring to FIG. 4, in the cell search procedure, initializing a timer (S401), acquiring time and frequency synchronization and detecting a physical layer cell identity (S403), and stopping the timer (S407) are the same as S301, S303, and S307, which are shown in FIG. 3, respectively.

However, the PBCH is decoded in S305 in an embodiment of the present invention shown in FIG. 3 while the SIB is decoded in S405 in another embodiment of the present invention shown in FIG. 4. The SIB decoding performed in S405 is illustrated as decoding SIB1 and SIB2 for convenience of description, but SIBs other than SIB1 and SIB2 may be decoded according to a communication environment.

That is, the cell search procedure according to another embodiment of the present invention includes measuring, as a cell search time of the MTC terminal, time taken in acquiring the time and frequency synchronization and detecting the physical layer cell identity in S403 and in decoding the SIB in S405 and comparing the measured time (that is, the timer value N) with a predetermined reference value (for example, 1 second) (S409), performing an access procedure of the low-rate LTE terminal when a result of the comparison is that the measured time is longer than the reference value (S411), and performing an access procedure of the normal LTE terminal when the comparison result is that the measured time is shorter than the reference value (S413).

As described above, the PBCH is a channel that broadcasts information including a system band, a PHICH configuration, and a system frame number (SFN). When the MTC terminal is set to use a fixed system band, not to use the PHICH, and deliver the SFN in a scheme different from the existing scheme, the PBCH decoding procedure may not be used. In another embodiment of the present invention, as described above, when the PBCH decoding procedure is not used, it is checked whether the cell search is successful using the SIB decoding.

According to the cell search procedure according to another embodiment of the present invention shown in FIG. 4, the MTC terminal may be configured to use two separate receiving structures simultaneously. Alternatively, one receiving structure may be used for the two purposes. That is, when the cell search is not successfully finished in a predetermined reference time, the MTC terminal may be configured to selectively increase a cell search time to perform a cell search.

A procedure for performing a random access to the base station via the uplink after finishing the cell search process as shown in FIG. 3 or 4 will be described below.

<First Random Access Step>

In a first random access step, the MTC terminal transmits a random access preamble to the base station. An uplink allocation resource, a subframe, and a transmission power should be determined for the MTC terminal to transmit the random access preamble. Here, since the MTC terminal may acquire information needed to transmit the random access preamble using information included in the SIB that is decoded in the cell search process, the MTC terminal is ready to transmit the random access preamble.

Since the present invention relates to a network access method of the MTC terminal that is in a poor radio environment, it is difficult for the base station to normally receive a signal transmitted by the MTC terminal even when the MTC terminal transmits the signal at the maximum allowable power.

Accordingly, in order to enhance received energy of the base station, the MTC terminal may be configured to repeatedly transmit the same random access preamble. However, since the base station cannot recognize a radio environment of the MTC terminal, the base station may not normally receive the random access preamble transmitted from the MTC terminal when the existing random access preamble transmission procedure is performed.

In the present invention, in order to prevent the above-described problems, random access preamble resources are divided into resources a normal LTE terminal uses and resources a low-rate MTC terminal uses.

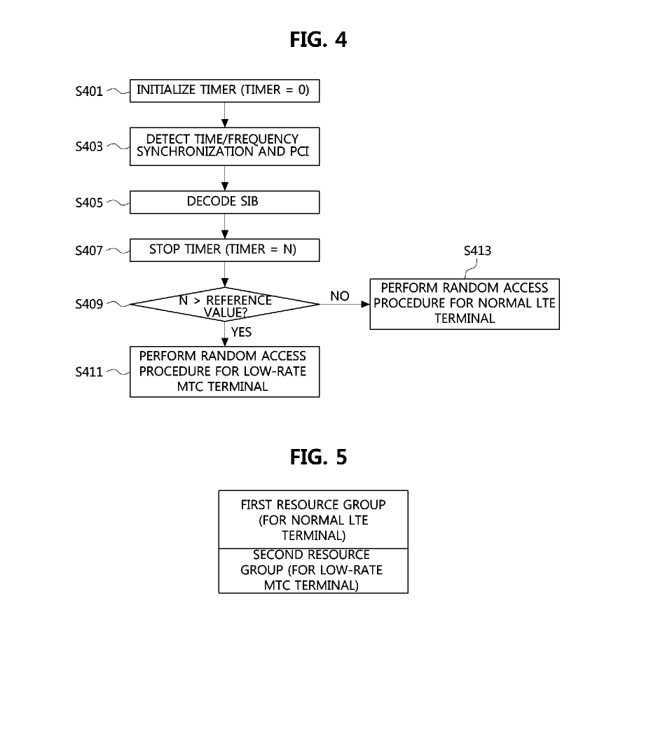

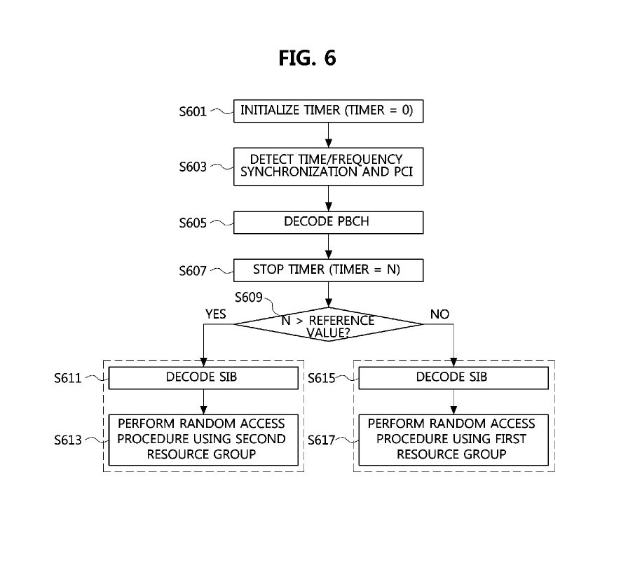

FIG. 5 is a conceptual view showing resources used in a random access method according to an embodiment of the present invention.

Referring to FIG. 5, the present invention includes dividing resources allocated to transmit the random access preamble into a first resource group and a second resource group, and the first resource group is used to transmit the random access preamble of the normal LTE terminal, and the second resource group is used to transmit the random access preamble of the MTC terminal. Here, each of the first resource group and the second resource group may denote a preamble sequence that may be selected in one cell by the LTE terminal and the MTC terminal.

In the LTE standard specification of the 3GPP, 64 preamble sequences that are available for each cell are divided into resources for a contention-based random access and resources for a contention-free-based random access.

In the present invention, the 64 preamble sequences that are available for each cell are divided into a preamble sequence for the normal LTE terminal (that is, the first resource group) and a preamble sequence for the MTC terminal (that is, the second resource group). Considering a resource occupation ratio by a type of the terminals in one cell, a ratio of the resources for the MTC terminal to the entire available resources is low. Accordingly, the size of the second resource group the MTC terminal uses may be less than the size of the first resource group the LTE terminal uses.

Like a method that is applied to the existing normal LTE terminal, the first resource group may be further subdivided into a resource region including preamble sequences used for a contention-based random access and a resource region including preamble sequences used for a contention-free-based random access. However, since most of low-rate MTC terminals do not need mobility support, the resource region that is used for a contention-free-based access for handover is not needed. Accordingly, the second resource group need not be further subdivided.

In addition, since the base station and the terminal should be aware of the division into the first resource group and the second resource group in advance, the base station needs to transmit resource division information to the terminal through the SIB. That is, the MTC terminal should be aware of a resource group from which the MTC terminal selects the random access preamble through the SIB decoding in the cell search process.

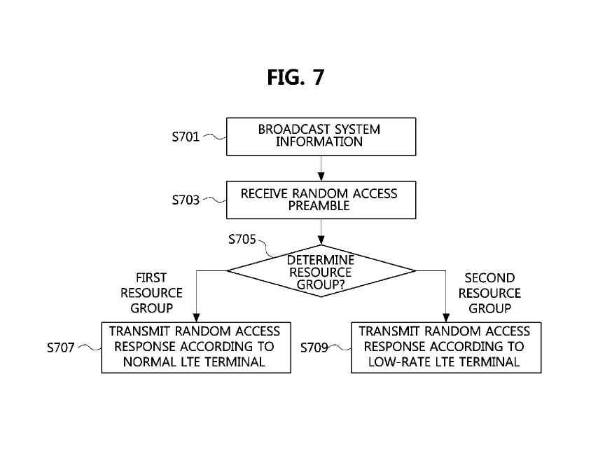

FIG. 6 is a flowchart showing a random access process according to an embodiment of the present invention.

Since S601 to S609 in the flowchart shown in FIG. 6 are the same as S301 to S309 shown in FIG. 3, a repetitive description thereof will be omitted.

Referring to FIG. 6, the MTC terminal compares time taken to perform a cell search by executing S601 to S609 with a reference value to determine a radio environment of the terminal, and then executes S611 to S613 when the radio environment is determined to be poor and executes S615 to S617 when the radio environment is determined not to be poor.

That is, the present invention includes performing duplexing to a case in which the radio environment is not poor and a case in which the radio environment is poor according to the radio environment of the terminal that is divided through the measurement of the cell search time to perform the SIB decoding and the random access procedure.

Specifically, when the radio environment is poor, the MTC terminal may acquire information needed in the random access process by repeatedly receiving the PDSCH including the SIB in the SIB decoding process (S611) to decode the SIB included in the PDSCH. Here, the MTC terminal may acquire resource group information (that is, the second resource group) that is needed to transmit the random access preamble.

Subsequently, the MTC terminal selects one preamble sequence to be transmitted through the PRACH among preamble sequences included in the second resource group based on the acquired information and then transmits the random access preamble to the base station using the selected preamble sequence (S613).

Meanwhile, when the radio environment is determined not to be poor in S609, the MTC terminal decodes the SIB according to the existing method (S615). Here, the LTE terminal or the MTC terminal may acquire resource group information (that is, the first resource group) to be used to transmit the random access preamble through the SIB decoding and select one of preamble sequences included in the first resource group based on the acquired information to transmit the selected preamble sequence to the base station (S617).

<Second Random Access Step>

When the normal LTE terminal or the MTC terminal transmits the random access preamble to the base station through S611 or S615 of FIG. 6, the base station may detect the random access preamble transmitted through the first resource group or the second resource group.

FIG. 7 is a flowchart showing operations performed by a base station during a random access process according to an embodiment of the present invention.

First, the base station broadcasts system information that is needed for a terminal entering a cell to access a network (S701). As described above, the base station may broadcast an MIB through the PBCH and broadcast an SIB through the PDSCH. In addition, as shown in FIG. 5, the SIB may include division information for resource groups that may be used for the normal LTE terminal and the low-rate MTC terminal to transmit the random access preamble.

The base station receives the random access preamble from the MTC terminal or the normal LTE terminal (S703). Here, the base station may receive the random access preamble through the PRACH.

Subsequently, the base station determines whether a preamble sequence included in the received random access preamble belongs to the first resource group or the second resource group (S705).

Here, upon detecting the preamble sequence that belongs to the first resource group, the base station transmits a random access response message for the normal LTE terminal (S707).

In addition, upon detecting the preamble sequence that belongs to the second resource group, the base station transmits a random access response message for the low-rate MTC terminal (S709). When the preamble sequence belongs to the second resource group, the base station may repeatedly transmit the random access response message a predetermined number of times and may repeatedly transmit until an identity of the MTC terminal is received from the MTC terminal.

The random access response message may include transmission of resource allocation information through the PDCCH and transmission of a message through the PDSCH. First, the terminal decodes the PDCCH because the terminal decodes the PDSCH using information about the decoded PDCCH.

According to the random access procedure defined in the existing 3GPP standard specification, when the normal LTE terminal transmits the random access preamble to the base station and does not receive the random access response from the base station within a specific time window, the normal LTE terminal attempts to retransmit the random access preamble. In this case, the terminal further increases the transmission power and changes the preamble sequence that is used in the random access preamble.

For the low-rate MTC terminal, the time window should be very long because the low-rate MTC terminal is required to receive the PDCCH and the PDSCH over several TTIs. The range of the TTI that should be extended by the low-rate MTC terminal to normally receive the PDCCH and the PDSCH may depend on which technique is applied in order to enhance the coverage of the PDCCH and the PDSCH. For example, in order to enhance the coverage of the PDCCH, an aggregation level that is originally set to 1, 2, 4, and 8 may be expanded to 16, 64, and 128. However, the PDCCH and the PDSCH may not be sufficiently received only in this method, and thus the base station may also apply a method of repeatedly transmitting the PDCCH and the PDSCH over several TTIs. The time window may be controlled using a combination of the two methods. As a result, the time window of the MTC terminal may be different from the time window of the normal LTE terminal.

<Third Random Access Step>

Upon normally receiving the random access response from the base station through the above-described second random access step, the MTC terminal acquires uplink resource allocation information and timing information from the received random access response and transmits an identity of the MTC terminal to the base station according to the acquired information. Here, the MTC terminal allows the base station to normally receive the identity of the MTC terminal from the MTC terminal, which is in a poor radio environment, by repeatedly transmitting the identity of the MTC terminal through the PUSCH.

As described above, in order to transmit the identity of the MTC terminal through the PUSCH, much more resources should be allocated to the MTC terminal than the information the MTC terminal intends to transmit through the PUSCH, and the MTC terminal should repeatedly transmit the identity through the PUSCH when the resources are not sufficient. Here, the number of repeated transmissions may vary depending on the radio environment of the MTC terminal. For example, like the above-described SCH, rather than finely divided, the radio environment is largely divided into two: one time transmission and ten time transmissions or more.

With the random access method for the machine type communication terminal as described above, the terminal determines a radio environment in a cell search process and performs a random access procedure using a resource corresponding to the determined radio environment among divided resources.

A normal LTE terminal and a low-rate MTC terminal have a difference by 100 times (or 20 dB) or more in terms of coverage, and thus the low-rate MTC terminal should use a different access procedure from the normal LTE terminal.

Accordingly, the present invention allows the access procedures of the normal LTE terminal and the low-rate MTC terminal to be divided and performed according to the radio environment, thereby enabling the MTC terminal that is in a very poor radio environment to access the base station to normally transmit and receive data.

Also, in the present invention, the random access procedure is duplexed, and the terminal recognizes a difference in the radio environment by itself and informs the recognized radio environment of the terminal to the base station through a dedicated resource corresponding to the radio environment.

In addition, even when the radio environment is poor, the data may be transmitted or received normally by differentially applying a signal delivery improvement scheme according to the radio environment in each random access procedure.

While the example embodiments of the present invention and their advantages have been described in detail, it should be understood that various changes, substitutions, and alterations may be made herein without departing from the scope of the invention.

What is claimed is:

1. A random access method performed by a terminal, the random access method comprising:
performing a cell search;
determining a radio environment based on time taken to perform the cell search; and
performing different random access procedures depending on the determined radio environment.

2. The random access method of claim 1, wherein the performing of the cell search comprises acquiring time and frequency synchronization and a physical layer cell identity and measuring time taken to completely decode a physical broadcast channel (PBCH).

3. The random access method of claim 1, wherein the performing of the cell search comprises acquiring time and frequency synchronization and a physical layer cell identity and measuring time taken to completely decode a system information block (SIB).

4. The random access method of claim 1, wherein the determining of a radio environment based on time taken to perform the cell search comprises comparing the time taken to perform the cell search with a reference time, determining the radio environment as a first radio environment when the time taken to perform the cell search is shorter than the reference value, and determining the radio environment as a second radio environment when the time taken to perform the cell search is longer than the reference value.

5. The random access method of claim 1, wherein the performing of different random access procedures depending on the determined radio environment comprises performing the random access procedures using predetermined different resources depending on the determined radio environment.

6. The random access method of claim 5, wherein the predetermined different resources have different sizes.

7. The random access method of claim 4, wherein the performing of different random access procedures depending on the determined radio environment comprises, when the determined radio environment is the first radio environment:
decoding a system information block;
acquiring first resource group information for transmitting a random access preamble from the decoded system information block; and
transmitting the random access preamble using any preamble sequence included in the first resource group.

8. The random access method of claim 4, wherein the performing of different random access procedures depending on the determined radio environment comprises, when the determined radio environment is the second radio environment:
decoding a system information block;
acquiring second resource group information for transmitting a random access preamble from the decoded system information block; and
transmitting the random access preamble using any preamble sequence included in the second resource group.

9. The random access method of claim 7, wherein the decoding of the system information block comprises repeatedly receiving and decoding the system information block.

10. The random access method of claim 7, wherein the transmitting of the random access preamble comprises repeatedly transmitting the random access preamble.

11. A random access method performed by a base station, the random access method comprising:
broadcasting system information including resource division information;
receiving a random access preamble transmitted based on the system information;
determining a used resource group from the received random access preamble; and
transmitting a random access response in a different scheme based on the determined resource group.

12. The random access method of claim 11, wherein the resource division information is division information of a first resource group and a second resource group a terminal selects and uses according to a radio environment determined by the terminal.

13. The random access method of claim 12, wherein the determining of a used resource group from the received random access preamble comprises determining whether a preamble sequence of the random access preamble belongs to the first resource group or the second resource group.

14. The random access method of claim 13, wherein the transmitting of a random access response in a different scheme based on the determined resource group comprises repeatedly transmitting the random access response when the determined resource group belongs to the second resource group.

15. The random access method of claim 13, wherein the transmitting of a random access response in a different scheme based on the determined resource group comprises transmitting the random access response using a plurality of transmission time intervals (TTIs) when the determined resource group belongs to the second resource group.
